(19) United States
(12) Patent Application Publication
(10) Pub. No.: US 2015/0242565 A1
(43) Pub. Date: Aug. 27, 2015

(54) METHOD AND DEVICE FOR ANALYZING MICROBIAL COMMUNITY COMPOSITION

(71) Applicants: Shenghui Li, Shenzhen (CN); Qiang Feng, Shenzhen (CN); Junjie Qin, Shenzhen (CN); Jianfeng Zhu, Shenzhen (CN); Yuanlin Guan, Shenzhen (CN); Jun Wang, Shenzhen (CN); Jian Wang, Shenzhen (CN); Huanming Yang, Shenzhen (CN)

(72) Inventors: Shenghui Li, Shenzhen (CN); Qiang Feng, Shenzhen (CN); Junjie Qin, Shenzhen (CN); Jianfeng Zhu, Shenzhen (CN); Yuanlin Guan, Shenzhen (CN); Jun Wang, Shenzhen (CN); Jian Wang, Shenzhen (CN); Huanming Yang, Shenzhen (CN)

(73) Assignees: BGI Shenzhen, Shenzhen (CN); BGI Shenzhen Co., Limited, Shenzhen (CN)

(21) Appl. No.: 14/419,060

(22) PCT Filed: Aug. 1, 2012
(86) PCT No.: PCT/CN2012/079492

§ 371 Date: Apr. 30, 2015

(51) Int. Cl. G06F 19/16

(52) U.S. Cl. CPC G06F 19/16

(57) ABSTRACT

The present teachings relate to analysis of a sample including a plurality of species. In one example, sequences of fragments of polynucleotides of the sample are obtained. A reference set comprising a plurality of sequences is obtained. An initial bin for each of the plurality of sequences of the reference set is determined based on a relative abundance of each sequence of the reference set in the sample. At least one final bin is obtained by modifying the initial bins for the plurality of sequences based on a model.

### TECHNOLOGY FIELD

The present invention relates to the field of metagenomics and bioinformatics, specifically to a method and system to analyze composition of microbial communities from environmental samples.

### BACKGROUND

Metagenomics is also known as environmental genomics, ecogenomics, ecological genomics, or community genomics. It is a subject of directly studying the microbial communities in natural state, including the total genomes of cultured and uncultured bacteria, fungi and viruses, in various environments (e.g. natural environment). It may have particular significance to the study of microbial flora composition and species diversity from all kinds of environments. For example, it is of great use to study human intestinal tract for understanding the flora clinical drug development as well as bacterial metabolic pathways. However, limited by traditional culture-based methods, composition of microorganisms in the environment (such as intestinal environment) is poorly understood. In particular, since the environment may contain uncultured bacteria, fungi or virus, identification of a majority of these communities remains inaccessible by the traditional culture-based methods.

The whole-genome shotgun sequencing of environmental samples has become popular in metagenomics. The method has revolutionized the analysis of the phylogenetic diversity for these complex microbial communities.

This method generally obtains by high-throughput sequencing large quantities of reads, and then assembles the reads into contigs, scaffolds or even the whole genome. At the same time, the shotgun approach is powered by next-generation high-throughput sequencing technologies, providing a good opportunity to study the community structure, community differences and function. Currently, metagenomic approaches alleviate the challenges in discovering new species and estimating diversity, of microbial communities and interaction of populations that inhabit niche environments such as oceans (Venter et al. 2004), soil (Daniel 2005), and human bodies (Gill et al. 2006).

However, when using metagenomics study (for example, WGS strategy) to analyze the composition of microbial community in environmental samples, there are still two significant challenges, i.e., the assembly of large quantities of short gene fragments (for example, sequencing reads) and the identification of different species. Since metagenomics collects all the genetic information of all the species in a particular environment, how to assemble large quantities of mixed short genetic fragments into contigs or scaffolds is a substantial problem and challenge. Meanwhile, after achieving the assembly of relatively long contigs or scaffolds, how to identify the species from which these long fragments originated is also a substantial problem and challenge.

Several programs including Velvet (Zerbino and Birney 2008), EULER-SR (Chaisson and Pevzner 2008), Newbler (Mergulies et al. 2006), and SOAPdenovo (Li et al. 2009) have been developed for assembly of mixed short fragments. In addition, binning methods have been widely used to identify originating species of contigs and scaffolds. The binning methods include but are not limited to similarity-based approaches, such as MEGAN (Huson et al. 2007) and CARMA (Tzahor et al. 2009), which are based on assignment fragments by alignment to the reference genome, and composition-based approaches, which utilize the signature of fragments such as GC content, k-mer frequencies (Schbath et al. 1995) or tetranucleotide frequencies (Teeling et al. 2004) for assignment. The latter method is largely limited by the length of fragments and the ability to distinguish sequence characteristics. Binning methods also include abundance-based binning, such as AbundanceBin (Wu and Ye 2011), which classifies fragments based on the abundance of different of species in the environment and is only appropriate for short reads.

However, metagenomic study aims at reconstruction of microbial genomes from environmental samples and the analysis of compositions of microbial community. The above-described methods separate the process of assembly and binning, focusing on just one aspect. Therefore, the above-described methods do not fully achieve the purposes of metagenomics study. Furthermore, even if the above-described assembly and binning methods are simple combination of assembly and binning, since algorithms, steps and compatibility used by different methods do not necessarily match, it is still difficult to predict whether the final results will achieve the purposes of metagenomic study, and whether the final results are accurate and effective.

Hence, this field would benefit from a high-efficiency and high-precision method to analyze composition of microbial community from environmental samples.

### SUMMARY OF THE INVENTION

In the present invention, unless otherwise indicated, the scientific and technical terms used herein have the meaning as commonly understood by those skilled in art. In addition, laboratory procedures employed in the examples described herein may be conventional and commonly used in the corresponding field. Meanwhile, in order to better understand the present invention, the following definitions and explanations of the related terms are provided.

As used herein, the term “environment” refers to a variety of environments broadly such as, but not limited to, the natural environment (e.g. soil environment, marine environment, river environment) and the internal environment (such as oral environment, intestinal environment). More precisely, the term “environment” refers to any area within which microorganisms/microbial communities may exist.

As used herein, the term “environmental sample” refers to a sample from a variety of environments containing microorganisms/microbial communities.

As used herein, the term “microorganism” has the meaning as commonly understood by the skilled in the art, such as, but not limited to, bacteria, fungi and viruses.

As used herein, the terms “microbial communities” and “microflora” both refer to the combination of various types of microorganisms which live together in a particular environment. Typically, various microorganisms in the same microbial community have direct or indirect interactions not only within themselves, but also with their environment: changes in the environment will lead to variation in the composition of the microbial communities (including microorganisms species and/or abundance); in return, variation in the composition of the microbial communities also affects the environment.

As used herein, the term “metagenome” refers to the sum of genomes of various biological species in the communities. Particularly, in the context of the method and apparatus of the present invention, the term “metagenome” refers to the sum of the genomes of a variety of microorganisms in the microbial community. Accordingly, the term “metagenome sequencing data” refers to data obtained by sequencing the entire metagenome. Because the DNA information contained in metagenome is vast in amount, high-throughput sequencing technology (for example, next-generation sequencing technology, or third-generation sequencing technology) is often used. However, it is also possible to obtain metagenom sequencing data through other methods or from other sources. The sequencing data is generally composed of a large quantity of sequencing fragments (read).

“Next-generation sequencing technology” or “third-generation sequencing technology” are well known in the art, which comprise 454 sequencing method (Roche), Solexa sequencing meth (Illumina), SOLID sequencing meth (ABI) or True Single Molecule Sequencing. A reference to the detailed review of next-generation sequencing methods can be found at Michael Metzker (2010), Sequencing technologies-the next generation, Nature Genetics. A detailed review of third-generation sequencing technology can be found in an article by Eric E. Schadt.et.al., A window into third-generation sequencing, Human Molecular Genetics, 2010, Vol. 19, Review Issue 2, R227-240.

The meaning of the term “low quality sequence” is well known in the art, which can be determined, for example, by sequencing platform and sequencing software in a sequencing process (Quality Scores for the Next-Generation Sequencing, Technical Note: Sequencing Illumina).

As used herein, the term “remove redundancy” refers to the process of reserving only one of sequences that have 95% or more similarity to each other, for example, by removing duplicate contigs and scaffolds.

As used herein, a “reference set” refers broadly to the assembled fragments set or genes set, wherein assembled fragments correspond to long fragments such as contigs and scaffolds obtained by assembly of sequencing fragments; a genes set refers to a collection of genes predicted from assembled fragments. The assembled fragment or the gene, which makes up reference set, is called an “element”.

As used herein, the term “binning” has the same meaning as that for “clustering”; the term “bin” and “class” have the same meaning. They may be used interchangeably.

As used herein, the meanings of “multivariate normal distribution model” and “maximum likelihood function” are commonly understood by one skilled in art. A detailed description about the two terms can be found in, for example, Fraley and Raftery, 1998.

As used herein, the term “similarity-based binning approach” means to measure similarity (or distance) between sequences by comparing the identities of two sequences, and to cluster based on the degree of such measured similarity (or distance). The term “composition-based binning approach” refers to the method of measuring the similarity (or distance) between sequences based on their composition characteristics, such as oligonucleotides frequency, GC content, etc., and clustering based on the degree of such measured similarity (or distance). Similarity-based binning methods include, but not limited to, MEGAN (Huson et al. 2007) and CARMA (Tzahor et al. 2009). Composition-based binning methods include such as, but not limited to, GC content based, k-mer frequencies based (Schbath et al. 1995) or tetranucleotide frequencies based (Teeling et al. 2004) binning methods.

The present invention is to solve a technical problem, and provides an effective method and apparatus for analysis of composition of microbial community in environmental samples. Based on this, the inventors creatively integrate the assembly method and binning methods, and then develop a high-efficiency and high-precision method and apparatus to analyze metagenomics sequencing data from environmental samples and to identify composition of microbial community of environmental samples. In particular, the method of present invention is also named as SOAP Series of Metagenome Analysis (hereinafter abbreviated as SoapMeta).

Therefore, in one aspect, the present invention provides a method for analysis of composition of microbial community in environmental samples, comprising the following steps:

### 1) Sequencing

Performing library construction and sequencing on the genomic DNA extracted from an environmental sample, in order to obtain metagenome sequencing data consisting of reads pool.

### 2) Preliminary Assembly

2a) constructing or completing the reference set: assembling sequencing reads to obtain assembly fragments, removing redundancy , so as to construct a final non-redundant reference set (namely assembled fragments set). Optionally, predicting genes from assembled fragments, and designating the set of predicted genes to be a reference set (or genes set). Or, if a known reference set exists for an environmental sample, then it may be used as the reference set directly. Alternatively, it can be done by combining the known reference set and the reference set constructed by sequencing fragments, and then removing redundancy to obtain an ultimate reference set.

2b) constructing a matrix of relative abundance profiles of elements: aligning sequencing fragments to the reference set, and calculating relative abundance of each element of the reference set in the sample.

3) Binning: initial bins of elements are determined via the following steps:

3a) Abundance-based binning: First, calculating the correlation coefficient between two elements based on the relative abundance of the elements in the sample; then using methods such as Pearson correlation coefficient, Spearman correlation coefficient, kendall correlation coefficient, the Euclidean distance, Mahalanobis distance and so on. Then, based on the correlation between two elements, a clustering algorithm, such as hierarchical clustering scheme (HIERARCHICAL CLUSTERING SCHEMES, STEPHEN C. JOHNSON, 1967), etc., is used to classify close correlation elements into one bin in order to determine initial bin of each element.

3b) Model-based binning:

(i) With respect to each of the initial bins as an independent multivariate normal distribution model, which is defined by the abundance distribution of contigs inside the bin, calculate the model parameters of the bin using the maximum likelihood function;

(ii) construct a fuzzy matrix to store the affiliation relationship of every element to every bin, and

(iii) reiterate E-step and M-step as described below until the likelihood function is maximized:

E-step: according to the model parameter of each bin, calculate the posterior probability that each element belongs to a particular bin, and update the probability in the fuzzy matrix that the element belongs to the particular bin;

M-step: according to the fuzzy matrix, obtain the model parameters of each bin by using the maximum-likelihood function.

### 4) Advanced Assembly Based on Bins

4a) Align all reads to the fragments of each bin and collected the metagenomics sequencing reads which mapped better than an identity threshold;

4b) Assemble these reads by SOAPdenovo or other assembly software for microbial sequencing data;

4c) Using a similarity-based or composition-based binning approach, confirm the precision of the assembly result. Optionally, re-bin the elements within each particular bin and the result therefrom can be used to divide the bin into more than one bins to achieve higher precision or maintained as one, thereby improving the reliability of the result;

4d) repeat steps 4a)-4c), until the size of genome sequence in each bin is not extended (growth rate of total length is less than 5%).

### 5) Demonstration of Assembled Genomes

Using the genomic sequence of the respective bin, determine the category of each bin corresponding microorganism, thereby determining the microbial communities in the environmental sample.

### Sequencing:

In a preferred embodiment, the environmental samples are obtained from natural environment (e.g. soil environment, marine environment, river environment). In another preferred embodiment, the environmental samples are derived from internal environment (such as oral environment, intestinal environment).

In a preferred embodiment, next-generation sequencing technology (e.g. 454, Solexa, SOLID or True Single Molecule Sequencing) or third-generation sequencing technology is used to perform sequencing on environmental samples which contain metagenome of microbial community, in order to obtain metagenome sequencing data from environmental samples.

In a preferred embodiment, metagenomic sequencing data was obtained through the following steps:

1a) providing environmental samples;

1b) extracting metagenome DNA from the environmental samples;

1c) constructing DNA library with the metagenome DNA;

1d) performing sequencing on the DNA library preferably by means of Solexa sequencing in order to obtain metagenome sequencing data from environmental samples.

In a preferred embodiment, metagenomic sequencing data is a reads pool which consists of sequencing fragments. The sequencing fragments can usually be obtained through next-generation sequencing technologies (e.g. Solexa sequencing) or third-generation sequencing technologies.

In a preferred embodiment, the sequencing fragments are paired-end reads.

The sequencing fragments may contained the sequence of the connector (adapter) used in the sequencing process, the low quality sequence and / or, in the case of analysis of samples from the in vivo environment, the host genome sequence. Such sequences may affect subsequent processing and analysis. Therefore, the removal of such sequences may be advantageous.

Therefore, in a preferred embodiment, before the step 2), preliminary analysis of sequencing data is performed, such as filtering adapter contamination, low quality reads or sequences of host genome.

In a preferred embodiment, multiple samples in the same or similar environment are sequenced, and all the samples' sequencing data is integrated to be metagenomic sequencing data.

In a preferred embodiment, the metagenome sequencing depth is at least 10×, preferably at least 20×, preferably at least 30×, preferably at least 40×, more preferably at least 50×.

### Preliminary Assembly

In one preferred embodiment, assemble sequencing fragments into assembled fragments (e.g., contigs and/or scaffolds) by SOAPdenovo. This assembly method is known to the skilled in art, such as reference Li et al. 2009.

In a preferred embodiment, multiple samples of environment are used and the reference set of each sample is obtained respectively in the present invention. In this case, the reference sets of all the samples are combined with redundancy removed, so as to construct the final non-redundant reference set. Namely, combine reference sets of multiple samples and remove redundancy, in order to construct the final non-redundant reference set.

In one preferred embodiment, if the environmental samples have a known reference set, then use it as the reference set directly. It can also be combination of the known reference set and the reference set constructed by sequencing fragments in step 2a), and then remove redundancy to obtain ultimate reference set.

For example, in the study of the human intestinal microflora MWAS, Junjie Qin et al (2010) A human gut microbial gene catalog established by metagenomic sequencing, Nature, 464:59-65, 3.3M Europeans intestinal non-redundant genes set of microbial communities (i.e., the reference set) has been constructed and published. Accordingly, in a preferred embodiment, the environmental sample is human intestinal sample. The 3.3M Europeans intestinal non-redundant genes set of microbial communities was combined with the reference set constructed in step 2a) and then redundancy was removed, providing the final reference genes set.

In a preferred embodiment, the step of aligning sequencing fragments to reference set is conducted by means of SOAP 2 or MAQ. SOAP 2 and MAQ are known to the skilled in art, such as reference R Li et al. 2009 and Li et al. 2008.

In a preferred embodiment, align sequencing fragments to the reference set using SOAP 2, and calculate relative abundance of each element in the reference set by following formula:

$${α}_{i} = \frac{{x}_{i} / {L}_{i}}{{\sum }_{j} ( {x}_{i} / {L}_{i} )} ,$$

αᵢ: The relative abundance of element i in the sample.
Lᵢ: The length of element i.
xᵢ: The times which element i is detected in the sample (the number of mapped reads).

### Binning

In a preferred embodiment, the initial bins of elements are determined by the following steps: First, calculate the correlation coefficient between two elements based on the relative abundance of the elements in the sample, for example, Pearson correlation coefficient, Spearman correlation coefficient, Kendall correlation coefficient, the Euclidean distance, Mahalanobis distance and so on. Then, based on the correlation between two elements, a clustering algorithm, such as hierarchical clustering scheme, etc., is used to classify close correlation elements into one bin in order to determine initial bin of each element.

After binning in step 3), a bin was identified as a group of elements which had good covariance of their abundance in many samples, such as normal distribution. Those elements clustered into a bin would have the following possible: 1) elements belongs to the same species (or plasmid) might have the same abundance and be clustered the bin; 2) elements from symbiotic species might also be clustered because of the similar abundance distributions of symbiotic species; 3) several species that have the common sequences, those common sequences might be clustered into an additional bin since the abundance of them is low relative to each species.

### Bin-Based Advanced Assembly

In a preferred embodiment, align sequencing fragments to the elements of the bin by SOAP2.

In a preferred embodiment, use GC-depth spectra classifier and/or tetranucleotide frequencies (TNFs) classifier (Teeling et al. 2004) to modulate.

### Demonstration of Assembled Genomes

In a preferred embodiment, perform alignment of genome sequences of each bin to the known genome database, in order to annotate their taxonomy.

In a preferred embodiment, said genome databases include, but not limited to sequenced genomes bacterial database NCBI/IMG, and NR database of NCBI.

In a preferred embodiment, the assembled genomes were aligned to sequenced genomes database by BLASTN (nucleic acid level) and/ or TBLASTX (protein level).

In another aspect, the present invention provides a system for analysis of microbial community composition in environmental samples, comprising the following modules:

1) Sequencing module

Used for performing DNA library construction and sequencing of the environmental sample, in order to obtain metagenome sequencing data consisting of reads pool.

2) Preliminary assembly Modules: linked with the sequencing module, and including the following modules linked with each other:

2a) assembly and construct module: the reference sets of all the samples are assembled and redundancy removed, so as to construct the final non-redundant reference set (namely assembled fragments set). Optionally, predicting genes from assembled fragments, and designating the set of predicted genes to be a reference set (or genes set).

2b) aligning module: align sequencing fragments to reference set, and calculate relative abundance of each element of the reference set in the sample.

3) Binning Modules, which are linked with assembly and construct module, and are used for determining the initial bins of each of the elements and include the following modules linked with each other:

3a) Abundance-based binning module: determine the initial bins of the elements based on abundance.

3b) Model-based binning module: determine the bins of the elements based on a model.

4) Advanced Assembly Module, which is linked with sequencing module and binning modules, is used for aligning all reads to the fragments of the bin and collecting the metagenomics sequencing reads which mapped better than an identity threshold, assembling these reads and confirming the precision of the assembly result.
5) Demonstration Module, which linked with advanced assembly module, is used for determining the category of each bin corresponding microorganism using the genomic sequence of the respective bin, thereby determining the microbial communities in the environmental sample, and classifying the contigs into taxonomic categories if the species taxonomy difference of them is obvious.

In a preferred embodiment, the environmental samples are derived from natural environment (e.g. soil environment, marine environment, river environment). In another preferred embodiment, the environmental samples are derived from internal environment (such as oral environment, intestinal environment).

In a preferred embodiment, next-generation sequencing technology (e.g. 454, Solexa, SOLiD or True Single Molecule Sequencing) or third-generation sequencing technology is used to perform sequencing on environmental samples which contain metagenome of microbial community, in order to obtain metagenome sequencing data from environmental samples.

In a preferred embodiment, the system includes DNA extraction module and library construction module that are linked with each other. The DNA extraction module is used for extracting metagenome DNA from the environmental samples, and the library construction module, which is linked with DNA construction module, is used for constructing DNA library with the metagenome DNA.

In a preferred embodiment, the sequencing fragments are paired-end reads.

In a preferred embodiment, the system also includes a filter module, which is linked with sequencing module and preliminary assembly modules. This module is used for filtering adapter contamination, low quality reads or sequences of host genome.

In a preferred embodiment, the metagenome sequencing depth is at least 10×, preferably at least 20×, preferably at least 30×, preferably at least 40×, more preferably at least 50×.

In one preferred embodiment, the assembly and construct module assembles sequencing fragments into assembled fragments (e.g., contigs and/or scaffolds) by SOAPdenovo.

In a preferred embodiment, the assembly and construct module also includes an acceptance sub-module, which is used for accepting known reference sets. In a preferred embodiment, the assembly and construct module regards the accepted known reference sets as final reference sets. In another preferred embodiment, the assembly and construct module combines reference sets from acceptance sub-module and that constructed by sequencing fragments, and then removes redundancy, in order to construct the final non-redundant reference set.

In a preferred embodiment, the assembly and construct module combines reference sets of multiple samples and removes redundancy, in order to construct the final non-redundant reference set.

In a preferred embodiment, the step of aligning sequencing fragments to reference set is conducted by means of SOAP 2 or MAQ.

In a preferred embodiment, align sequencing fragments to reference set by means of SOAP2, and calculate relative abundance of each element in the reference set by following formula:

$${α}_{i} = \frac{{x}_{i} / {L}_{i}}{{\sum }_{j} ( {x}_{i} / {L}_{i} )} ,$$

αᵢ: The relative abundance of element i in the sample.
Lᵢ: The length of element i.
xᵢ: The times which element i is detected in the sample (the number of mapped reads).

In a preferred embodiment, the abundance-based binning module is based on the relative abundance of the elements in the sample. First, calculate the correlation coefficient between two elements. Then, based on the correlation between two elements, a clustering algorithm is used to classify close correlation elements into one bin in order to determine initial bin of each element.

In a preferred embodiment, the model-based binning module determines the initial bins of elements by the following steps:

(i) With respect to each of the initial bins as an independent multivariate normal distribution model, which is defined by the abundance distribution of contigs inside the bin, calculate the model parameters of the bin using maximum likelihood function;

(ii) construct a fuzzy matrix to store the affiliation relationship of every element to every bin, and

(iii) reiterate E-step and M-step as described below until the likelihood function is maximized:

E-step: according to the model parameter of each bin, calculate the posterior probability that each element belongs to a particular bin, and update the probability in the fuzzy matrix that the elements belongs to the bin;

M-step: according to the fuzzy matrix, obtain the updated model parameters of each bin by using the maximum-likelihood function.

In a preferred embodiment, the advanced assembly module implements its function by the following steps:

(a)Align all reads to the fragments of each bin determined by binning module and collected the metagenomics sequencing reads which mapped better than an identity threshold;

(b)Assemble these reads by SOAPdenovo or other assembly software for microbial sequencing data;

(c)Perform a similarly or composition-based binning approach to confirm precision of the assembly result. Optionally, re-bin the elements within each particular bin, based on the result of which, the bin will be divided into several bins for more precision or maintained as one if already best, thereby improving the reliability of the result;

(d) repeat the step (a)-(c), until the size of genome sequence in each bin is not extended (growth rate of total length is less than 5%).

In a preferred embodiment, the advanced assembly module aligns sequencing fragments to elements of the bin by means of SOAP 2.

In a preferred embodiment, the advanced assembly module use GC-depth spectra classifier and/or tetranucleotide frequencies (TNFs) classifier to modulate.

In a preferred embodiment, the demonstration module performs alignment of genome sequences of each bin to the known genome database, in order to annotate their taxonomy.

In a preferred embodiment, the known genome databases include, but not limited to sequenced genomes bacterial database NCBI/IMG, and NR database of NCBI.

In a preferred embodiment, the assembled genomes were aligned to sequenced genomes database by BLASTN (nucleic acid level) and/ or TBLASTX (protein level).

In another aspect, also provides the use of the apparatus of the present invention is used in the analysis of environmental samples microbial community composition. In a preferred embodiment, the environmental sample is derived from the natural environment, such as the soil environment, and the marine environment, and the river environment. In another preferred embodiment, the environmental sample from the in vivo environment, such as the oral environment and the intestinal environment.

### Beneficial Effects of Invention

The method and apparatus of the present invention may be based on the high-throughput sequencing technology. Performing assembly of the sequencing data from multiple samples in the same or similar environment, clustering and second assembly to obtain species composition and genomic information of microbial community, may have very broad application prospects. Compared with the prior art, conventional method for assembly, the method and apparatus of the present invention may have the following advantages:

First, through combining property of various sequences systematically to construct metagenome reference set of microbial community, SoapMeta is especially suitable for microbial species classification and genome reconstruction from sequencing data of multiple samples extracted from the same habitat.

Second, creative integration of the binning process and assembly allows greater accuracy in assembled result of species genomes, and high-efficiency and high-precision analysis of the composition of microbial community.

Third, soapMeta, first the first time, allows clustering analysis based on multiple samples and advanced assembly.

Clustering analyses on multiple samples may have two distinct advantages: 1) more low abundance species are covered, which leads to a more comprehensive study; 2) due to the environmental factors, different samples would have a different species composition and abundance, which favors comparative studies. By contrast, metagenomics analyses which performed on single sample was only beneficial on accurate dominant species (like Hess et al. 2011), but not on comprehensive analysis of the microbial communities, especially low abundance species.

The drawings and specific embodiment of the present invention will be described in detail in the following and skilled in the art will understand the same. The following drawings and embodiments are only used to illustrate the present invention, rather than limiting the scope of the present invention. According to the drawings and the following detailed descriptions of the preferred embodiment, the various objects and advantageous aspects of the present invention will become apparent to the skilled in the art.

### BRIEF DESCRIPTION OF DRAWINGS

FIG. 1 schematically shows the flow diagram of the present invention SoapMeta, wherein dashed hollow box, solid hollow box and solid box indicate origins from three different species;

FIG. 2 schematically shows the flow diagram of preliminary assembly of the present invention SoapMeta;

FIG. 3 schematically shows the flow diagram of binning of the present invention SoapMeta;

FIG. 4 schematically shows the flow diagram of advanced assembly of the present invention SoapMeta;

FIG. 5 shows the structure diagram of apparatus of the present invention SoapMeta;

FIGS. 6-8 show the GC-depth spectra of three samples (sample A-C), which are obtained from the first strategy in Example 2, where FIG. 6 shows sample A; FIG. 7 shows sample B; FIG. 8 shows sample C, and some bacteria of sample B and C were hard to distinguish because the GC content and sequencing depth was very similar;

FIG. 9 shows the information diagram of taxonomy assignment from 16S rRNA sequencing in Example 3;

FIG. 10 shows the correlation between the number of 16S rRNA tags of the genus Akkermansia from 16S rRNA sequencing method and the sequencing depth of corresponding assembled genomes from SoapMeta; and

FIG. 11 shows the correlation between the number of 16S rRNA tags of the genus Lactobacillus from 16S rRNA sequencing method and the sequencing depth of corresponding assembled genomes from SoapMeta.

### DETAILED DESCRIPTION OF THE PRESENT INVENTION

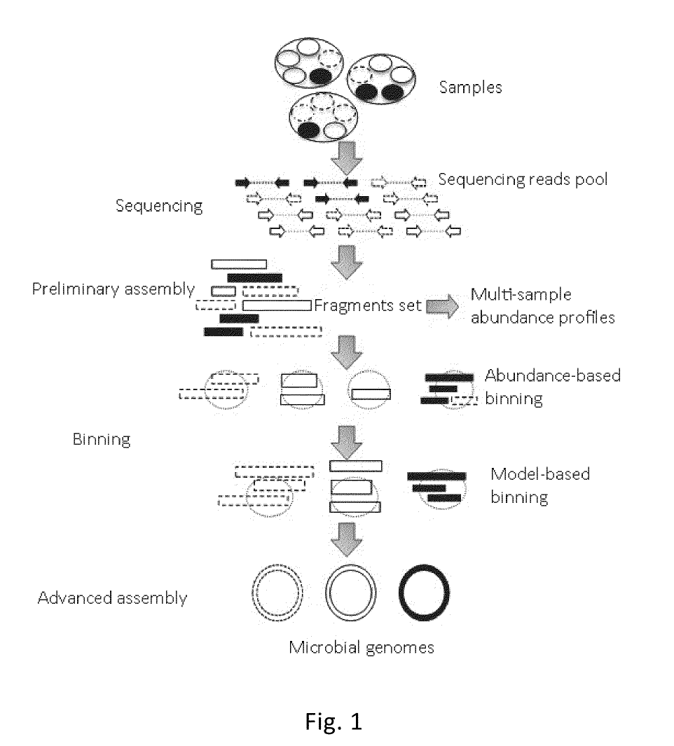

The present invention is further disclosed based on the following non-limiting examples. FIG. 1 depicts an exemplary flow diagram of the present invention SoapMeta. In this figure, origins from three different species are illustrated and they correspond to dashed hollow, solid hollow, and solid boxes in FIG. 1.

Unless otherwise stated, the technical means used in the examples are known to the skilled in the art (J. Sambrook et al. Molecular Cloning: A Laboratory Manual, second edition (1989) and F. M. Ausubel et al. Short Protocols in Molecular Biology, John Wiley & Sons, Inc., third edition (1995)). The usage of virus enzyme is under conditions recommended by manufacturers of such enzymes. Anything not discussed herein in detail are known to the public in this field. The embodiments of the present invention are described by way of examples and not intended to limit the scope of the present invention.

### EXAMPLE 1

### Analysis of Simulated Environmental Samples

1. Simulation data

To simulate the environmental samples, we selected 100 different bacteria genomes randomly from the Proteobacteria phylum of NCBI database (Wheeler et al. 2007), and the bacteria strains of the same species was unique.

To estimate the performance of SoapMeta, we had simulated to 10 samples with an equal sequencing amount 720M per sample, by using short paired-end sequencing within parameters: reads length 90 bp, insert size 500±20 bp (mean±SD) and error ratio 0.1%. To ensure a high biodiversity of complex environment, we used the Broken-Stick model (MacArthur 1957) to compose the relative species abundance of simulated samples. In this model, the sequencing amount of most bacteria in a single sample is very low (64% bacteria within a relative species abundance <1%), that is hard to binning and assembly of separate sample. However, of all samples, those bacteria were sequenced within 13.6˜182.0 Mbp amount and 2.7˜160.4 X depth.

2. Preliminary assembly

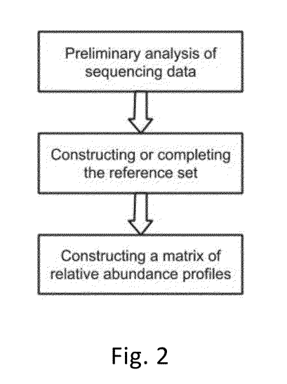

FIG. 2 depicts an exemplary flow diagram of the preliminary assembly process of the present invention. Assemblers performing on metagenome reads were able to use, and we had integrated the SOAPdenovo (Li et al. 2009) into our pipeline. A multi-sample mixed assembly strategy is recommended, but with limited computing power (usually memory consumption). Moreover, for the separate assembly strategy, we also propose a redundancies removal step by combining assembled contigs from multiple samples. A reference set consists of assembled contigs, scaffolds or predicted genes, used as materials of binning.

Based on the simulation data set, assembly of mixed samples was performed and 41,754 contigs (namely reference set) with length 200∞2,001,157 bp (N50=93,353 bp) were obtained (N50 is a judgment standard to measure the quality of the genome map, which means, when all the sequences obtained by assembly are in accordance with the descending order of the length, and descending to be added to the length of the sequences until the total length obtained by adding reaches 50 percent of the total length of all assembled sequences, the length of that sequence is N50. Miller et al. 2010. Assembly algorithms for next generation sequencing data. Genomics. 95(6): 315-327, incorporated herein by reference). The contigs were aligned to the original bacteria genomes by BLASTN for determining the source of them. After that, the assembled contigs shows covering average 88.7% of the original genomes. The coverage of each bacterium shows positive correlation with the sequencing depth but a sequencing depth above 20× does not significantly affect the coverage.

Align sequencing fragments to reference set by means of SOAP2, and calculate relative abundance of each element (contig) in the reference set by following formula:

$${α}_{i} = \frac{{x}_{i} / {L}_{i}}{{\sum }_{j} ( {x}_{i} / {L}_{i} )} ,$$

αᵢ: The relative abundance of element (contig) i in the sample.
Lᵢ: The length of element (contig) i.

xᵢ: The times which element (contig) is detected in the sample (the number of mapped reads).

### 3. Binning

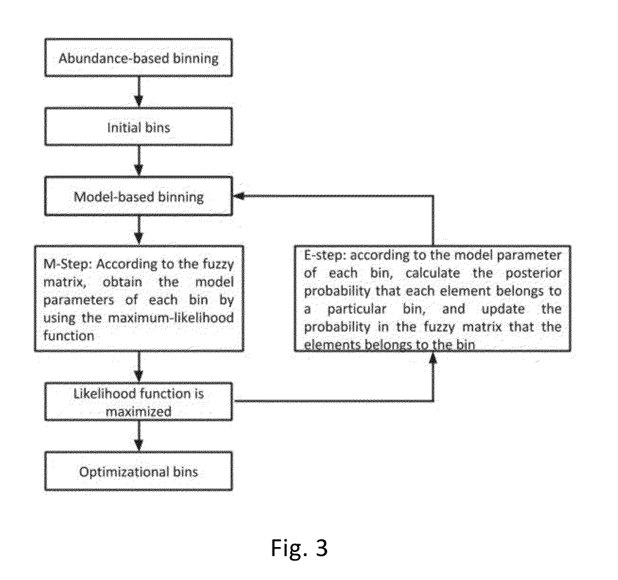

An exemplary flow diagram of the binning process is depicted in FIG. 3.

3.1 Abundance-based binning (initial binning)

First, calculate the Kendall's tau correlation coefficient between each two contigs based on the matrix of relative abundance profiles. Then, based on the correlation between each two elements, hierarchical clustering scheme is used to classify close correlation elements into one bin in order to determine initial bin of each element.

In this study, we filtered the bins that consisting of less than 10 contigs using default binning parameters. Finally, 343 initial bins were derived, which covered 96.8% (40,438/41,754) of original contigs.

For each bin, the best matched bacterium was defined as the bacterium which most contigs are from. The precision was defined as the percentage of contigs overall length from the best matched bacterium. The initial bins were rather accurate with a precision 50.3%˜100.0% (average 95.1%).

3.2 Model-based binning

Then, we optimize the initial bins using model-based binning, in short:

1) With respect to each of the initial bins as an independent multivariate normal distribution model, which is defined by the abundance distribution of contigs inside the bin, calculate the model parameters of the bin using the maximum likelihood function;

2) construct a fuzzy matrix to store the affiliation relationship of every element to every bin, and

3) reiterate E-step and M-step (iterative expectation-maximization (EM) algorithm) as described below until the likelihood function is maximized:

E-step: according to the model parameter of each bin, calculate the posterior probability that each element belongs to a particular bin, and update the probability in the fuzzy matrix that the elements belongs to the bin;

M-step: according to the fuzzy matrix, obtain the updated model parameters of each bin by using the maximum-likelihood function.

After such iterative optimization, the initial bins were reduced to 135 final bins; with a lower covered ratio 91.9% (38,364/41,754) of contigs and a lower precision 33.2%˜100.0% (average 92.3%). Each bin represents one species. Based on the sequence of contigs in the bin, 86% (86/100) of original bacteria was covered more than 50% by the final bins, as some low assembly ratio bacteria were hard to be covered.

4. Advanced Assembly

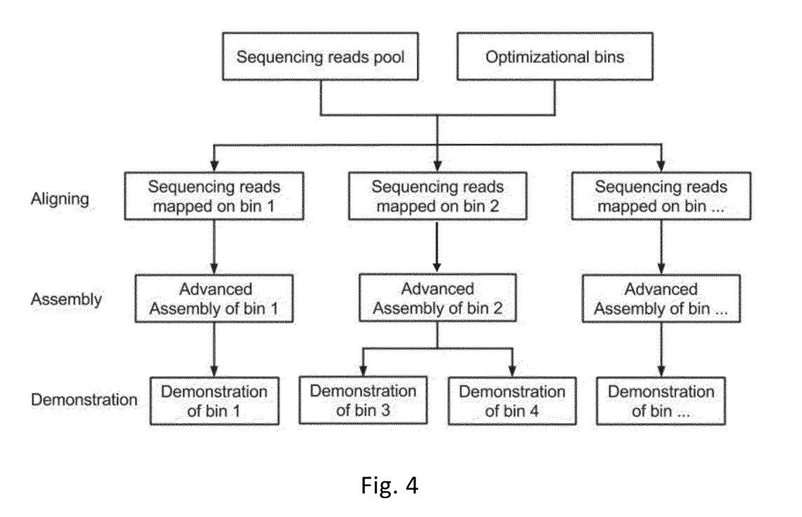

The advanced assembly process is illustrated in FIG. 4, which comprises the following steps: 1) By using SOAP2, align all simulated reads to the fragments of each bin that determined as above and collected the metagenomics sequencing reads which mapped better than an identity threshold; 2) Assemble these reads by SOAPdenovo ; 3) Perform a similarly or composition-based binning approach to confirm precision of the assembly result. Re-bin the elements within each particular bin, based on the result of which, the bin will be divided into several bins for more precision or maintained as one if already best.; 4) repeat the step 1)-3), until the size of genome sequence in each bin is not extended (growth rate of total length is less than 5%).

Of our simulation data set, advanced assembly was performed for the previous 135 bins and 148 assembled genomes were obtained. A slight increase of genomes is likely due to the fact that the composition-based approach divides some bins by distinct difference of GC content or sequencing depth.

The assembled genomes achieve an average precision of 94.2%, which is slightly larger than the previous bins (Table 1), and a covered ratio of 95% (95/100) of original bacteria. Moreover, the average coverage of assembled genomes by original bacteria is 95.5%, but of original bacteria by assembled bins is only 57.4%.

We identified 95 of the 100 original bacterium based on the assembled genomes of each of the 148 bins, and as described as above, the coverage of assembled genomes by each original bacteria is more than 50%.

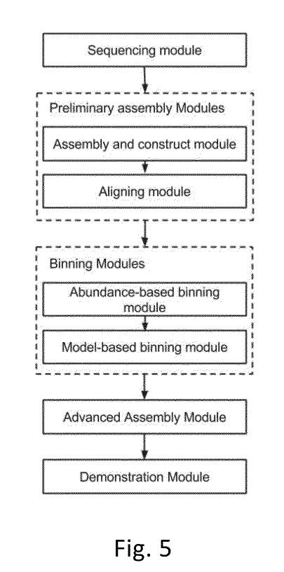

The result shows high specificity of SoapMeta, which can effectively identify most species (95%) of the simulated samples. FIG. 5 depicts a structure diagram of an exemplary apparatus of SoapMeta according to an embodiment of the present invention.

TABLE 1
Statistics of bins at each step

| | No. | Covered | Contigs | Covered |
|---|---|---|---|---|
| | of | initial contigs | average | origin |
| | bins | (%) | precision (%) | bacteria (%) |
| Initial bins | 343 | 96.8 | 95.1 | 90 |
| Optimization bins | 135 | 91.9 | 92.3 | 86 |
| Assembled bins | 148 | — | 94.2 | 95 |

### EXAMPLE 2

### Analysis of Data From Simple Environmental Samples (Cellulose Degradation Flora)

To estimate the performance of real data of SoapMeta, we programmed the pipeline to a low complexity real environment, the cellulose degradation flora, and compared with the traditional methods to confirm the advantage of the present invention SoapMeta.

In this embodiment, we collected three samples (Sample A, B and C) of cellulose degradation flora, which were cultivated in different control conditions. The three samples were collected from the same marsh soil cultivated by three different carbon sources medium respectively (filter paper, cellobiose, glucose) at 37° C. for 52 hours, thereby obtaining the sample A, B and C. We constructed the sequencing library (90 bp paired-end and 500±20 bp insert size) for each sample and sequenced with HiSeq2000 instrument. High quality reads were extracted from raw reads by filtering the low quality sequences and adapter contamination, obtaining total 3.88 Gbp metagenome sequencing data (namely the total sequences data of the three samples)for analysis.

In this embodiment, two approaches were used to assemble and reconstruct potential microbial genomes from those samples. The first approach is the traditional analysis method. Using this approach, it is to assemble and bin each sample respectively (MEGAN (Husonet al.2007)). The second approach is the present invention called SoapMeta, which uses sequencing data of all samples to perform preliminary assembly, binning and advanced assembly in order to reconstruct potential microbial genomes. Comparing with the traditional approach, the advantage of the present invention SoapMeta in multiple samples' assembly was evident.

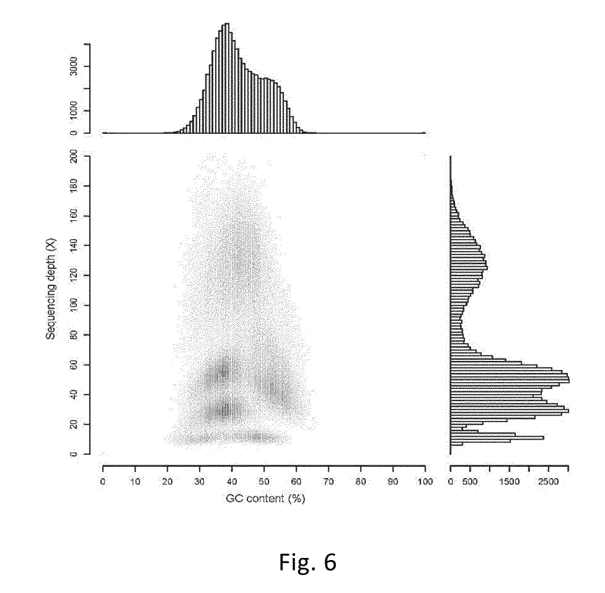

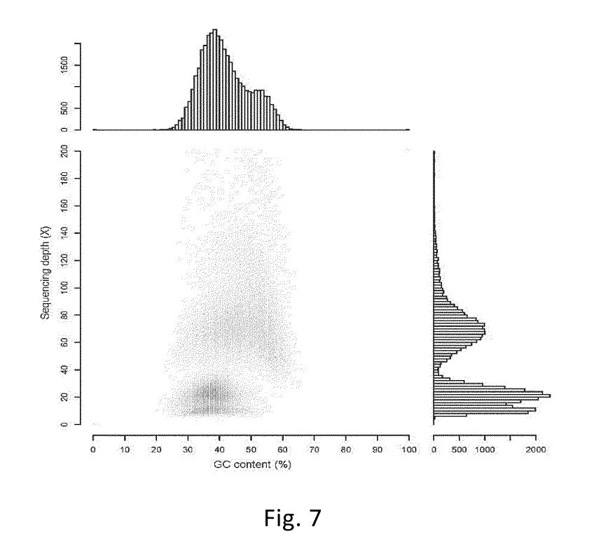

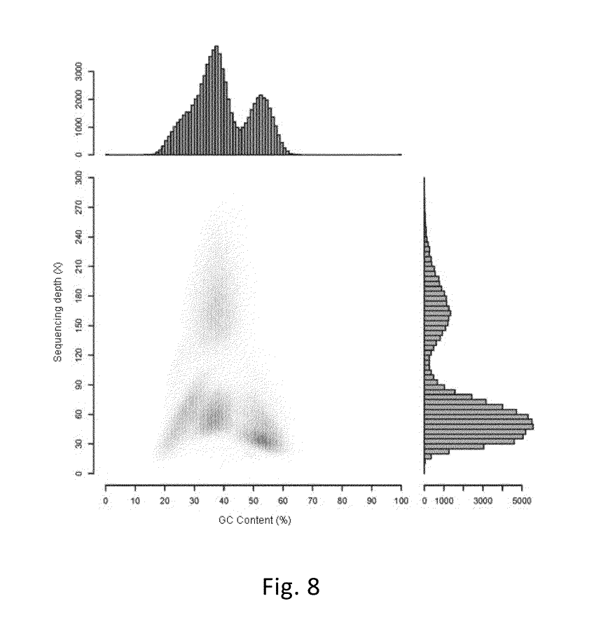

Using the first approach, a composition-based binning approach was proposed to identify the potential microbial genomes from a single sample. We identified 6, 2 and 3 bins from sample A, B and C respectively. The GC-depth spectra of each sample were showed on FIG. 6-8. It is obvious that some bacteria of sample B and C were hard to distinguish because the GC content and sequencing depth were much closer.

Using SoapMeta process of the present invention, a relative abundance plot of the preliminary assembled contigs was obtained, indicating that bacteria contigs have strong relation between different samples. At last, 10 bins from three samples were identified, and 9 of these were of genome sizes larger than 1 Mbp. The 10 bins covered average 89.5% sequencing reads of samples. Each of the 10 bins corresponded to a potential bacterial genome. We aligned the bins to the sequenced bacteria genomes by TBLASTX, and the result was shown in Table 2.

Of the 10 bins, 6 hit the significant homology bacteria (Table 2): Brevibacillus brevis NBRC 100599, Bacillus coagulans 2-6, Bacillus halodurans C-125, Clostridium botulinum A2 Kyoto, Clostridium thermocellum ATCC 27405, Clostridium thermocellum ATCC 27405. Moreover, the Clostridium thermocellum is a famous cellulose-degrading bacterium (Weimer and Zeikus 1977, Bayer et al. 1983, and Schwarz 2001), and the genera Brevibacillus and Bacillus were also known having the ability to degrade cellulose (Liang et al. 2009, Li et al. 2006, and Rastogi et al. 2009).

From the result above, it is obvious that the performance of SoapMeta is significantly better than the first strategy, both in the accuracy and species coverage. SoapMeta is a more high-efficiency and high-precision method to analyze composition of microbial community from environmental samples.

TABLE 2
Assembly genomes summary of the cellulose degradation flora.

| | | Total | | Sequencing depth | | | Correspond to the | | | | % Coverage |
|---|---|---|---|---|---|---|---|---|---|---|---|
| Bin | No. of | length | % GC | on each sample | | | bin of each sample | | | Nearest bacterial genome | (mean |
| ID | contigs | (bp) | content | A | B | C | A | B | C | (TBLASTX) | identity) |
| M2 | 239 | 5,071,223 | 51.7 | 52.2 | 81.4 | 44.6 | A2 | B1* | C2 | Brevibacillus brevis | 68.2 (62.6) |
| | | | | | | | | | | NBRC 100599 | |
| M4 | 1,814 | 4,451,734 | 36.8 | 26.4 | 9.8 | 155.2 | A5 | B2* | C1 | Bacillus coagulans | 55.2 (55.6) |
| | | | | | | | | | | 2-6 | |
| M9 | 275 | 3,606,596 | 36.7 | 54.7 | 27.4 | 61.2 | A6 | B2* | C3* | Bacillus halodurans | 47.3 (54.8) |
| | | | | | | | | | | C-125 | |
| M6 | 484 | 2,896,376 | 27.0 | 7.4 | 2.1 | 58.8 | A3 | | C3* | Clostridium botulinum | 86.5 (81.9) |
| | | | | | | | | | | A2 Kyoto | |
| M1 | 1,205 | 4,887,520 | 41.5 | 119.1 | 67.0 | 3.5 | A1 | B1* | | Clostridium thermocellum | 43.8 (56.2) |
| | | | | | | | | | | ATCC 27405 | |
| M3 | 707 | 1,801,720 | 38.6 | 4.6 | 22.5 | 1.5 | | B2* | | Clostridium thermocellum | 75.0 (77.7) |
| | | | | | | | | | | ATCC 27405 | |
| M7 | 4,265 | 3,451,777 | 40.9 | 6.8 | 13.4 | 4.7 | | B2* | | Unknown | |
| M8 | 1,224 | 3,213,511 | 47.5 | 11.7 | 2.4 | 0.8 | A4 | | | Unknown | |
| M5 | 2,011 | 2,492,642 | 34.2 | 1.5 | 9.3 | 2.3 | | B2* | | Unknown | |
| M10 | 557 | 302,883 | 36.4 | 3.3 | 5.2 | 1.0 | | | | Unknown | |

Note:
*in the Table indicates that the bin contains sequences of multiple species, and cannot be distinguished further. For example, B1* indicates that bin B1 contains sequences of multiple species, which are unable to be further distinguished. But by using the second strategy, the bin B1 is further distinguished into Brevibacillus brevis NBRC 100599 and Clostridium thermocellum ATCC 27405.

### EXAMPLE 3

### Analysis of Data From High Complexity Environmental Samples (Mouse Gut Microflora)

As another estimation of SoapMeta, we focus on a real, high complexity environment, the mouse gut microflora.

### Mouse Gut Microflora

The fecal samples were collected from two common mice, the SV-129 and C57Black/6 strains (Fujii et al. 1997). The relative abundance of the gut microbe in the mouse was varible due to the difference of age, gender, diet and so on. However, the microbial composition was not much changed for a specific mouse fed in a certain environment. Therefore, SoapMeta is appropriate in decoding the microflora and recovering the microbial genomes from that.

We collected 13 fecal samples (6 samples from SV-129 mouse and 7 samples from C57Black/6 mouse) and constructed sequencing library (90 bp paired-end and 350±15 bp insert size) for each sample and sequenced with HiSeq2000 instrument. High quality reads were extracted from raw reads by filtering the adapter contamination, low quality sequences and the contamination sequences of mouse genome. After that, we obtained 3.96±0.55 Gbp (mean±SD) metagenome sequencing data for analysis.

According to the present invention SoapMeta:

1) First, a preliminary assembly of metagenome sequencing data of samples was performed to obtain a 246.1 Mbp contigs set (n=180,056, N50=2,613bp);
2) After the binning process, 213.6 Mbp (86.8%) sequences were clustered into 325 bins on the threshold 100 kbp. 56 bins with length more than 1 Mbp were performed to advanced assembly; and
3) Then, 57 assembled genomes were obtained by advanced assembly, within a total length of 141.6 Mbp (average genome size 2.48 Mbp); and the genomes covered average 49.5% reads of samples. The result is hereby shown in Table 3.

The assembled genomes were aligned to sequenced genomes database by BLASTN (nucleic acid level) and TBLASTX (protein level). 8 assembled genomes that hit closely (>90% precision and >95% identity) to the bacteria at nucleic acid level were assigned to known bacteria. The other 48 hit with significant homology (>70% precision and >50% identity) to the bacteria at protein level were assigned to related bacteria. The other 1 was assigned to unknown bacteria.

TABLE 3
57 assembled genomes (bins)

| | BLASTN | | | TBLASTX | | | |
|---|---|---|---|---|---|---|---|
| | Best matched bacterium | % contigs | Mean | Best matched bacterium | | Mean | Taxonomy |
| ID | (BLASTN) | (precision) | identity | (TBLASTX) | % contigs | identity | assignment |
| 218 | Akkermansia_muciniphila_{—} | 100.00 | 98.66 | Akkermansia_muciniphila_{—} | 99.99 | 95.36 | Akkermansia |
| | ATCC_BAA_835_uid58985 | | | ATCC_BAA_835_uid58985 | | | (genus) |
| 126 | Bacteroides_3_1_40A_{—} | 93.86 | 99.07 | Bacteroides_3_1_40A_uid62053 | 99.92 | 94.79 | Bacteroides |
| | uid62053 | | | | | | (genus) |
| 97 | Bacteroides_D20_uid42369 | 92.12 | 97.68 | Bacteroides_ uniformis_ATCC_{—} | 97.74 | 92.30 | Bacteroides |
| | | | | 8492_uid54547 | | | (genus) |
| 23 | Bacteroides_D20_uid42369 | 91.05 | 97.13 | Bacteroides_ uniformis_ATCC_{—} | 96.73 | 89.99 | Bacteroides |
| | | | | 8492_uid54547 | | | (genus) |
| 268 | Bacteroides_intestinalis_{—} | 91.30 | 98.25 | Bacteroides_xylanisolvens_{—} | 100.00 | 74.64 | Bacteroides |
| | DSM_17393_uid54881 | | | SD_CC_1b_uid47865 | | | (genus) |
| 149 | Bacteroides_intestinalis_{—} | 99.25 | 97.84 | Bacteroides_intestinalis_{—} | 99.73 | 90.02 | Bacteroides |
| | DSM_17393_uid54881 | | | DSM_17393_uid54881 | | | (genus) |
| 136 | Escherichia_coli_UTI89_{—} | 98.28 | 99.07 | Escherichia_coli_536_uid58531 | 99.98 | 96.08 | Escherichia |
| | uid58541 | | | | | | (genus) |
| 41 | Lactobacillus_johnsonii_{—} | 93.81 | 96.90 | Lactobacillus_johnsonii_FI9785_{—} | 97.11 | 87.74 | Lactobacillus |
| | NCC_533_uid58029 | | | uid41735 | | | (genus) |
| 43 | Unclassified | 99.16 | | Alistipes_putredinis_DSM_17216_{—} | 98.43 | 61.87 | |
| | | | | uid54803 | | | |
| 63 | Unclassified | 98.36 | | Anaerotruncus_colihominis_DSM_{—} | 88.02 | 56.69 | |
| | | | | 17241_uid54807 | | | |
| 154 | Unclassified | 98.84 | | Bacteroides_2_1_56FAA_uid68193 | 98.96 | 63.12 | Bacteroides |
| | | | | | | | (genus) |
| 105 | Unclassified | 88.08 | | Bacteroides_2_2_4_uid55581 | 96.17 | 59.26 | Bacteroides |
| | | | | | | | (genus) |
| 137 | Unclassified | 92.95 | | Bacteroides_2_2_4_uid55581 | 98.64 | 60.89 | Bacteroides |
| | | | | | | | (genus) |
| 58 | Unclassified | 87.50 | | Bacteroides_20_3_uid50765 | 98.55 | 59.52 | Bacteroides |
| | | | | | | | (genus) |
| 229 | Unclassified | 95.52 | | Bacteroides_3_1_40A_uid62053 | 98.31 | 76.56 | Bacteroides |
| | | | | | | | (genus) |
| 59 | Unclassified | 98.66 | | Bacteroides_3_1_40A_uid62053 | 96.71 | 60.62 | Bacteroides |
| | | | | | | | (genus) |
| 135 | Unclassified | 98.07 | | Bacteroides_3_1_40A_uid62053 | 98.09 | 56.26 | Bacteroides |
| | | | | | | | (genus) |
| 73 | Unclassified | 96.52 | | Bacteroides_3_1_40A_uid62053 | 96.95 | 62.44 | Bacteroides |
| | | | | | | | (genus) |
| 42 | Unclassified | 96.56 | | Bacteroides_9_1_42FAA_uid55587 | 96.29 | 60.25 | Bacteroides |
| | | | | | | | (genus) |
| 17 | Unclassified | 97.68 | | Bacteroides_D20_uid42369 | 99.72 | 57.67 | Bacteroides |
| | | | | | | | (genus) |
| 109 | Unclassified | 96.99 | | Bacteroides_eggerthii_1_2_{—} | 96.43 | 58.67 | Bacteroides |
| | | | | 48FAA_uid61869 | | | (genus) |
| 21 | Unclassified | 93.19 | | Bacteroides_fluxus_YIT_12057_{—} | 96.85 | 60.20 | Bacteroides |
| | | | | uid66157 | | | (genus) |
| 51 | Unclassified | 98.68 | | Bilophila_wadsworthia_3_1_6_{—} | 92.23 | 76.41 | |
| | | | | uid61875 | | | |
| 11 | Unclassified | 97.35 | | Bryantella_formatexigens_DSM_{—} | 95.87 | 58.87 | |
| | | | | 14469_uid54943 | | | |
| 20 | Unclassified | 98.79 | | Bryantella_formatexigens_DSM_{—} | 96.01 | 60.65 | |
| | | | | 14469_uid54943 | | | |
| 86 | Unclassified | 47.69 | | Capnocytophaga_oral_taxon_329_{—} | 97.15 | 61.56 | |
| | | | | F0087_uid66905 | | | |
| 67 | Unclassified | 97.13 | | Clostridium_bolteae_ATCC_BAA_{—} | 95.73 | 59.77 | |
| | | | | 613_uid54523 | | | |
| 26 | Unclassified | 96.62 | | Clostridium_bolteae_ATCC_BAA_{—} | 90.22 | 58.06 | |
| | | | | 613_uid54523 | | | |
| 8 | Unclassified | 97.05 | | Clostridium_bolteae_ATCC_BAA_{—} | 82.92 | 57.68 | |
| | | | | 613_uid54523 | | | |
| 80 | Unclassified | 99.43 | | Clostridium_bolteae_ATCC_BAA_{—} | 90.15 | 59.81 | |
| | | | | 613_uid54523 | | | |
| 162 | Unclassified | 98.25 | | Clostridium_bolteae_ATCC_BAA_{—} | 97.27 | 60.38 | |
| | | | | 613_uid54523 | | | |
| 238 | Unclassified | 99.49 | | Clostridium_D5_uid63427 | 97.38 | 56.41 | |
| 57 | Unclassified | 95.23 | | Clostridium_D5_uid63427 | 91.56 | 54.94 | |
| 226 | Unclassified | 72.00 | | Clostridium_hathewayi_DSM_13479_{—} | 97.57 | 61.43 | |
| | | | | uid55373 | | | |
| 110 | Unclassified | 99.19 | | Clostridium_hathewayi_DSM_13479_{—} | 95.51 | 59.94 | |
| | | | | uid55373 | | | |
| 2 | Unclassified | 95.51 | | Clostridium_hathewayi_DSM_13479_{—} | 83.31 | 59.56 | |
| | | | | uid55373 | | | |
| 114 | Unclassified | 93.98 | | Clostridium_HGF2_uid61051 | 92.61 | 55.17 | |
| 15 | Unclassified | 94.07 | | Clostridium_nexile_DSM_1787_{—} | 96.11 | 66.53 | |
| | | | | uid55077 | | | |
| 60 | Unclassified | 94.23 | | Clostridium_nexile_DSM_1787_{—} | 96.03 | 60.38 | |
| | | | | uid55077 | | | |
| 34 | Unclassified | 68.63 | | Desulfovibrio_salexigens_DSM_{—} | 93.77 | 50.46 | Desulfovibrionaceae |
| | | | | 2638_uid59223 | | | (family) |
| 141 | Unclassified | 100.00 | | Lactobacillus_animalis_KCTC_{—} | 96.93 | 83.92 | Lactobacillus |
| | | | | 3501_uid67869 | | | (genus) |
| 27 | Unclassified | 99.31 | | Lactobacillus_reuteri_DSM_{—} | 89.37 | 88.77 | Lactobacillus |
| | | | | 20016_uid58471 | | | (genus) |
| 26_2 | Unclassified | 99.49 | | Olsenella_uli_DSM_7084_{—} | 96.84 | 52.61 | |
| | | | | uid51367 | | | |
| 98 | Unclassified | 58.94 | | Roseburia_intestinalis_L1_82_{—} | 93.48 | 59.48 | Lachnospiraceae |
| | | | | uid55267 | | | (family) |
| 9 | Unclassified | 92.61 | | Roseburia_intestinalis_L1_82_{—} | 76.93 | 60.61 | Lachnospiraceae |
| | | | | uid55267 | | | (family) |
| 5 | Unclassified | 97.20 | | Roseburia_intestinalis_L1_82_{—} | 85.25 | 60.79 | Lachnospiraceae |
| | | | | uid55267 | | | (family) |
| 1 | Unclassified | 96.96 | | Roseburia_intestinalis_L1_82_{—} | 77.51 | 58.39 | Lachnospiraceae |
| | | | | uid55267 | | | (family) |
| 95 | Unclassified | 97.63 | | Roseburia_intestinalis_L1_82_{—} | 96.37 | 61.18 | Lachnospiraceae |
| | | | | uid55267 | | | (family) |
| 19 | Unclassified | 99.12 | | Roseburia_intestinalis_L1_82_{—} | 80.64 | 59.71 | Lachnospiraceae |
| | | | | uid55267 | | | (family) |
| 36 | Unclassified | 94.56 | | Roseburia_intestinalis_L1_82_{—} | 79.69 | 58.61 | Lachnospiraceae |
| | | | | uid55267 | | | (family) |
| 14 | Unclassified | 94.81 | | Roseburia_intestinalis_L1_82_{—} | 86.04 | 59.01 | Lachnospiraceae |
| | | | | uid55267 | | | (family) |
| 28 | Unclassified | 96.19 | | Roseburia_intestinalis_L1_82_{—} | 94.73 | 59.51 | Lachnospiraceae |
| | | | | uid55267 | | | (family) |
| 84 | Unclassified | 93.96 | | Roseburia_intestinalis_L1_82_{—} | 89.04 | 66.27 | Lachnospiraceae |
| | | | | uid55267 | | | (family) |
| 7 | Unclassified | 98.58 | | Roseburia_intestinalis_L1_82_{—} | 74.54 | 60.64 | Lachnospiraceae |
| | | | | uid55267 | | | (family) |
| 6 | Unclassified | 91.52 | | Roseburia_intestinalis_L1_82_{—} | 89.03 | 62.64 | Lachnospiraceae |
| | | | | uid55267 | | | (family) |
| 90 | Unclassified | 88.47 | | Roseburia_inulinivorans_DSM_{—} | 95.22 | 60.19 | Lachnospiraceae |
| | | | | 16841_uid55375 | | | (family) |
| 3 | Unclassified | 97.21 | | Unclassified | 63.84 | | |

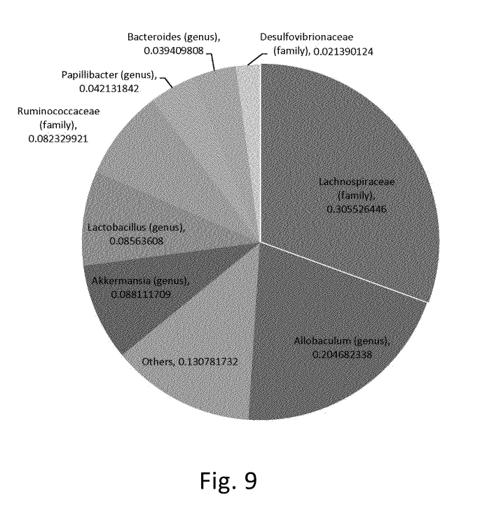

In order to confirm the above results, 16S rRNA V6 hypervariable region sequencing of those samples was performed using a Solexa sequencer. High quality tags were extracted from raw tags by filtering the adapter contamination, low quality sequences, overlap and primer sequences. After that, 3.63±0.68M (mean±SD) tags were obtained for the samples. Taxonomic assignment of the tags was performed by aligning to the RefSSU database (Huse et al. 2010) using BLASTN. The result is shown in FIG. 9. The high abundance bacteria of the mouse gut microflora were assigned to Lachnospiraceae, Lactobacillus, Allobaculum, Akkermansia, Ruminococcaeae, Papillibacter, Bacteroides and Desulfovibrionaceae, and most of those bacteria were covered by the assembled genomes from SoapMeta, implying high recall of SoapMeta pipeline.

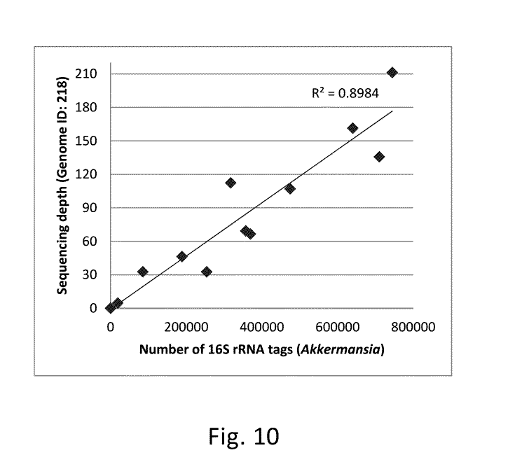

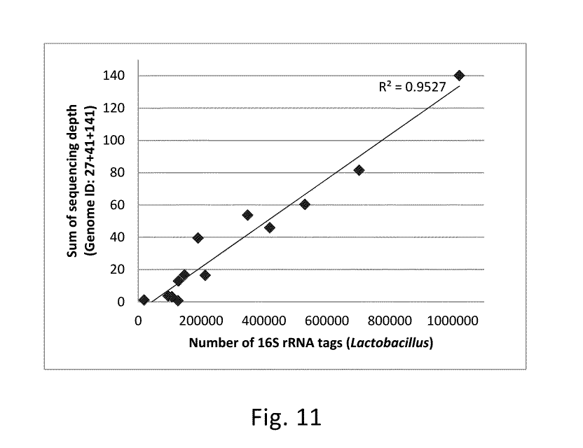

Moreover, the number of 16S rRNA tags of the genus Akkermansia and Lactobacillus were compared with the sequencing depth of corresponding assembled genomes from SoapMeta. FIGS. 10-11 show the correlation between 165 tags and the assembled genomes. FIGS. 10-11 show a high correlation coefficient of number of 16S rRNA tags from 16S rRNA sequencing method and the sequencing depth of corresponding assembled genomes from SoapMeta. This indicates that the result from SoapMeta is substantially consistent with 16S rRNA sequencing method. It was evident that SoapMeta was a reliable, high-efficiency and high-precision method.

The specific embodiment of the present invention has been described above in detail. As understood by those skilled in the art, modifications and substitutes of some of the details can be made. Such changes are all within the scope of the present invention. The full scope of the present invention is given by the appended claims and any of its equivalents.

1-10. (canceled)

11. A method for analyzing a sample comprising a plurality of species, comprising:
obtaining sequences of fragments of polynucleotides of the sample;
obtaining a reference set comprising a plurality of sequences;
determining an initial bin for each of the plurality of sequences of the reference set based on a relative abundance of each sequence of the reference set in the sample; and
obtaining at least one final bin by modifying the initial bins for the plurality of sequences based on a model.

12. The method of claim 11, further comprising obtaining reads of polynucleotides of the sample, wherein the step of obtaining the sequences of the fragments is by assembling the reads into the fragments.

13. The method of claim 11, wherein the sample is an environmental sample, wherein the sample comprises microorganisms or microbial communities.

14. The method of claim 11, wherein the step of obtaining the reference set comprises:
compiling the sequences of the fragments; and
removing redundancy from the sequences.

15. The method of claim 11, wherein the step of determining the initial bin comprises determining a correlation coefficient of the relative abundances for each pair of the sequences of the reference set.

16. The method of claim 15, wherein the correlation coefficient is based on at least one of a Pearson correlation coefficient, a Spearman correlation coefficient, a Kendall correlation coefficient, a Euclidean distance, a Mahalanobis distance, and a combination thereof.

17. The method of claim 11, wherein the modifying the initial bins comprises merging at least two initial bins, or splitting an initial bin into at least two bins.

18. The method of claim 11, wherein the modifying the initial bins comprises constructing a matrix including a probability of each of the sequences belonging to each of the initial bins.

19. The method of claim 11, wherein the modifying the initial bins comprises determining, for each initial bin, a parameter of a distribution of the relative abundances of the sequences in the initial bin.

20. The method of claim 19, wherein the step of determining the parameter is based on an expectation-maximization algorithm.

21. The method of claim 20, wherein the step of determining based on the expectation-maximization algorithm comprises iteratively calculating a posterior probability of each of the sequences belonging to each of the initial bins, and estimating the parameter based on the posterior probability.

22. The method of claim 12, further comprising determining which of the at least one final bin the reads belong to, by comparing the reads to the sequences of the at least one final bin.

23. The method of claim 22, further comprising assembling reads belonging to a same final bin.

24. The method of claim 11, further comprising splitting a final bin into at least two final bins.

25. The method of claim 24, wherein the step of splitting is based on a similarity or composition of the sequences in the final bin.

26. The method of claim 11, further comprising determining a species each of the fragments belongs to.

27. A system for analyzing a sample comprising a plurality of species, comprising:
a data acquisition module configured to obtain sequences of fragments of polynucleotides of the sample,
an assembly and construct module configured to obtain a reference set comprising a plurality of sequences;
an initial binning module configured to determine an initial bin for each of the plurality of sequences of the reference set based on a relative abundance of each sequence of the reference set in the sample; and
a final binning module configured to obtain at least one final bin by modifying the initial bins for the plurality of sequences based on a model.

28. The system of claim 27, wherein the data acquisition module comprises a sequencing module configured to obtain reads of polynucleotides of the sample.

29. The system of claim 28, wherein the data acquisition module comprises a preliminary assembly module configured to assemble the reads into the fragments.

30. The method of claim 27, wherein the sample is an environmental sample, wherein the sample comprises microorganisms or microbial communities.

31. The system of claim 27, wherein the assembly and construct module is configured to obtain the reference set by compiling sequences of the fragments and removing redundancy from the sequences.

32. The system of claim 27, wherein the initial binning module comprises an alignment module configured to align the fragments to the initial bins.

33. The system of claim 32, wherein the alignment module is configured to calculate a relative abundance of each sequence of the reference set in the sample.

34. The system of claim 27, wherein the initial binning module comprises an abundance-based binning module configured to determine the initial bin by determining a correlation coefficient of relative abundances for each pair of the sequences of the reference set.

35. The system of claim 34, wherein the correlation coefficient is based on at least one of a Pearson correlation coefficient, a Spearman correlation coefficient, a Kendall correlation coefficient, a Euclidean distance, a Mahalanobis distance and a combination thereof.

36. The system of claim 27, wherein the modifying the initial bins comprises merging at least two initial bins, or splitting an initial bin into at least two bins.

37. The system of claim 27, wherein the modifying the initial bins comprises constructing a matrix including a probability of each of the sequences belonging to each of the initial bins.

38. The system of claim 27, wherein the modifying the initial bins comprises determining, for each initial bin, a parameter of a distribution of the relative abundances of the sequences in the initial bin.

39. The system of claim 38, wherein the determining the initial bin is based on an expectation-maximization algorithm.

40. The system of claim 39, wherein the determining the initial bin based on the expectation-maximization algorithm comprises iteratively calculating a posterior probability of each of the sequences belonging to each of the initial bins, and estimating the parameter based on the posterior probability.

41. The system of claim 29, further comprising a demonstration module configured to determine which of the at least one final bin the reads belong to, by comparing the reads to the sequences of the at least one final bin.

42. The system of claim 41, further comprising an advanced assembly module configured to assembling reads belonging to a same final bin.
